(19) United States
(12) Patent Application Publication
(10) Pub. No.: US 2009/0181852 A1
(43) Pub. Date: Jul. 16, 2009

(54) Assays

(75) Inventors: Alan George Clark, West Lothian (GB); Mohamed Mutwahar Gani, Bedford (GB); Steven Howell, Perthshire (GB)

Correspondence Address: STEPTOE & JOHNSON LLP, 1330 CONNECTICUT AVENUE, N.W., WASHINGTON, DC, 20036, US

(73) Assignee: Inverness Medical Switerland GMBH, Zug (CH)

(21) Appl. No.: 12/084,895

(22) PCT Filed: Nov. 15, 2006
(86) PCT No.: PCT/IB2006/003228

§ 371 Date: Sep. 4, 2008

Related U.S. Application Data
(60) Provisional application No. 60/736,303, filed on Nov. 15, 2005.
(60) Provisional application No. 60/736,304, filed on Nov. 15, 2005.

(51) Int. Cl. C04B 30/00; C40B 60/10

(52) U.S. Cl. 506/7; 506/38

(57) ABSTRACT

Assays can determine multiple analytes in a sample, such as a biological marker and a drug-related compound.

### CLAIM OF PRIORITY

This application claims priority to provisional U.S. Patent Application Nos. 60/736,303 and 60/736,304, both filed on Nov. 15, 2005 and both titled “ASSAYS,” each of which is incorporated by reference in its entirety.

### FIELD OF THE INVENTION

The invention relates to assays.

### BACKGROUND

Assays can be used to determine compounds related to, for example, a physiological property of a subject.

### SUMMARY

The invention relates to assays.

In one aspect, a device includes a plurality of assay sites, the plurality including a first subset of assay sites configured to determine a first biological marker, and a second subset of assay sites configured to determine a first drug-related compound.

In another aspect, a method includes introducing a sample to a device comprising a plurality of assay sites, the plurality including a first subset of assay sites configured to determine a first biological marker, and a second subset of assay sites configured to determine a first drug-related compound, contacting the first and second subsets of assays with the sample, and determining at least one biological marker and at least one drug-related compound in the sample.

In another aspect, a method of monitoring a subject includes (a) obtaining a sample from the subject; (b) introducing a sample to a device comprising a plurality of assay sites, the plurality including a first subset of assay sites configured to determine a first biological marker, and a second subset of assay sites configured to determine a first drug-related compound, (c) contacting the first and second subsets of assays with the sample, and (d) determining at least one biological marker and at least one drug-related compound in the sample; and (e) repeating steps (a)-(d) at a later time.

The device can include a sample inlet, where the first and second subsets of assay sites are in fluidic communication with the sample inlet. The biological marker can be associated with a disease or disorder, and the drug-related compound can be associated with the disease or disorder. The device can include a third subset of assay sites configured to determine a second biological marker. The device can include a fourth subset of assay sites configured to determine a second drug-related compound. The second subset of assay sites can be configured to determine a drug, and the third subset of assay sites can be configured to determine a metabolite of the drug.

The first subset of assay sites can be configured to determine an oxidized lipid. The first subset of assay sites can be configured to determine HDL, LDL, HDL-ox, LDL-ox, HDL-MDA, HDL-CUSO4, DDLDL-MDA, SDLDL-CUSO4, ApoA, ApoB, HSA-MDA, HSA-CUSO4, LDL-MDA, or LDL-CUSO4. When the first subset of assay sites is configured to determine an oxidized lipid, the second subset of assay sites can be configured to determine a drug or drug metabolite. The drug or drug metabolite can be associated with a cardiac disease or disorder. The plurality of assay sites can further include a third subset of assay sites configured to determine HDL, LDL, HDL-ox, LDL-ox, HDL-MDA, HDL-CUSO4, DDLDL-MDA, SDLDL-CUSO4, ApoA, ApoB, HSA-MDA, HSA-CUSO4, LDL-MDA, or LDL-CUSO4.

In one aspect of the invention, a device is configured to determine one or more target compounds in a sample (e.g., a biological sample).

In some embodiments, the target compound(s) includes at least one drug-related compound and the device is configured to determine one or more (e.g., multiple) drug-related compounds in a sample. For example, the device can be configured to determine a drug and/or one or more (e.g., multiple) metabolites corresponding to the drug. The device can be configured to determine multiple drugs and/or one or more (e.g., multiple) metabolites corresponding to each of at least some (e.g., all) of the multiple drugs.

In some embodiments, the target compound includes a biomarker (biological marker) and the device is configured to determine one or more (e.g., multiple) biomarkers in a sample. The device can be configured to determine at least one drug-related compound and at least one biomarker. The device can be configured to determine the at least one drug-related compound and the at least one biomarker using the same sample (e.g., the device may be configured to determine the presence of at least one drug-related compound and at least one biomarker using a single volume of sample).

In some embodiments, the determination provides qualitative information for each of at least some of the target compounds. For example, the determination may be indicative of whether a target compound is present in a sample or whether a target compound is present in an amount that exceeds a threshold. In some embodiments, the determination provides quantitative information. For example, the determination may be indicative of the amount (e.g., concentration) of target compound present. In some embodiments, the determination provides both qualitative and quantitative information. The determination may provide relative information. For example, the determination may be indicative of an amount of the target compound relative to an amount of a different compound present in the sample.

In some embodiments, the device includes one or more (e.g., multiple) assay sites each configured to participate in an assay (e.g., a sandwich assay or competitive assay) for at least one target compound (e.g., a drug-related compound or biomarker). The device can include a substrate (e.g., a chip, slide, or lateral flow support) with multiple assay sites disposed on the substrate. The assay sites may be disposed as an array (e.g., as a linear or two-dimensional array). In some embodiments, the assay sites for different target compounds are disposed in an irregular (e.g., random) pattern.

In some embodiments, one or more (e.g., multiple) of the assay sites is configured with a respective binding compound that participates in an assay (e.g., a sandwich assay or competitive assay) for the determination of a respective target compound. The binding compounds of one or more assay sites may have a binding affinity for a target compound (e.g., an affinity for a drug-related compound, an analogue of a drug-related compound, a biomarker, an analogue of a biomarker, or a biological). Alternatively, or in addition, the binding compound of one or more of the assay sites may have a binding affinity for a second binding compound that itself has a binding affinity for a target compound.

The binding compound of one or more of the assay sites may include an antibody (e.g., a monoclonal or polyclonal antibody, an antibody fragment (e.g., Fab2 or Fab) or recombinant binding domains of antibody fragments, ScFv), enzyme, polynucleotide (e.g., DNA), lectin, or combination thereof. Exemplary antibodies include antibodies raised against a specific target compound (e.g., against a drug-related compound (or analogue) or biomarker (or analogue)).

Drugs typically include compounds having or suspected of having a therapeutic, preventative, and/or diagnostic effect on a subject. Drugs include drug candidates. Drugs may include, for example, small molecules, vaccines, proteins, enzymes, peptides, polypeptides, polynucleotides, therapeutic antibodies, and combinations thereof.

The drug-related compound may be a conjugate of the drug-related compound (e.g. a bovine serum albumin conjugated drug). Due to the small size of many drug-related compounds it is can be challenging to raise an antibody directly to the compound. In order to present the drug-related compound in format that will illicit an immune response in the host being used to raise an antibody, one can form a conjugate of the drug-related compound with a larger immunogenic molecule. When used in an assay format the drug-related compound may be used as a conjugate to ensure that the molecule is presented spatially in a format that will allow antibody binding to occur unhindered by steric effects.

In some embodiments, the biomarker is related to at least one lipid (including lipid-related compounds). The biomarker may be indicative of an oxidation state of the lipid. For example, a biomarker may be indicative of an oxidized lipid (e.g., oxidized-LDL or oxidized-HDL) or a non-oxidized lipid (e.g., non-oxidized LDL or non-oxidized HDL). In some embodiments, at least one biomarker is indicative of a relative oxidation state of the lipid. For example, at least one biomarker may be indicative of a lipid an oxidation state intermediate oxidized and non-oxidized forms of the lipid.

In one example embodiment one or more antibodies that have been raised to a specific small molecule, which may be a drug (or drug metabolite) or a conjugate of a drug or drug metabolite may be immobilised to the respective elements of a sensor array. Additionally, one or more antibodies that have been raised against one or more biomarkers may also be applied to the array. Where more than one specific antibody species is immobilised, these may be applied in a random (known) order across the matrix to avoid potential systematic errors when sample measurements are made. As such, immobilisation may occur by a process of direct adsorption. However immobilisation of said antibodies may also be achieved using a range of functional chemistries as will be understood by one skilled in the art. When a sample (typically a biological sample) that contains the biomarker, small molecule, drug or metabolites thereof is applied to the sensor, signals may be recorded and monitored on each segment of the array.

### DESCRIPTION OF THE DRAWINGS

FIG. 1a is a cross sectional view of an assay device.

FIG. 1b shows a cross sectional view of an assay device according to another embodiment.

FIG. 2 represents a perspective view of a measurement surface.

FIG. 3a shows a schematic representation of a competitive binding assay format.

FIG. 3b shows a schematic representation of a sandwich assay format.

FIG. 3c shows a schematic representation of an alternative competitive binding assay format.

FIG. 4 represents a series of data that describe the change in the levels of several biomarkers in response to treatment of a subject with a drug therapy. The data also show the levels of the drug.

FIG. 5 represents the response of a assay device to a range of samples containing a biomarker.

### DETAILED DESCRIPTION

A drug is administered to a subject. A sample obtained from the subject is assayed for one or more target compounds (e.g., for at least one drug-related compound and at least one biomarker). The drug-related compound(s) may include, for example, the drug itself and/or one or more compounds related to drug metabolism, uptake, or degradation (e.g., a drug metabolite). The biomarker(s) are typically indicative of or related to a property of the subject. In general, the biomarkers have or are suspected of having a relationship with one or more of the drug-related compounds. For example, the drug may be a drug having or suspected of having an effect on a subject's vascular system (e.g., a statin) and the biomarker may independently be a compound indicative of a property of the vascular system (e.g., a lipid (e.g., LDL and HDL) or a matrix metalloproteinase (e.g., MMP-1, or MMP-9)). Samples obtained from the subject at one or more different times are assayed for the target compound(s).

Examples of target compounds (e.g., drug-related compounds and biomarkers) are described in U.S. Provisional Application No. 60/712,393, and International Patent Application IB2006/002352, filed Aug. 29, 2006, each of which is incorporated by reference in its entirety.

In general, information (e.g., quantitative and/or qualitative) related to the target compounds determined from the analysis can be used, for example, in determining (e.g., evaluating or predicting) a patient response to a drug. For example, the present assays can be used in methods for determining a patient response to a drug as described in Provisional Application No. 60/712,393 and International Patent Application IB2006/002352.

Information related to the target compounds determined from the analysis can be used, for example, prior to a health-related event of a subject. For example, the subject may be administered one or more drugs as part of monitoring a therapeutic or preventative routine related to, for example, cardiac health. Samples from the subject are assayed to determine one or more target compounds related to the administered drug(s) and related biomarkers. Information from the assays can be used, for example, to monitor the efficacy of the therapeutic or preventative routine and/or to predict the occurrence of a health-related event. Exemplary biomarkers include biomarkers related to the integrity of arterial plaques.

Atherosclerosis is a cardiovascular inflammatory disease that occurs in major arteries and leads to heart attacks, stroke and peripheral disease. Low density lipoprotein (LDL) and its modified forms (e.g., oxidized forms) deposit cholesterol in cells of the vessel wall, including macrophages and smooth muscle cells, contributing to progression of atherosclerosis. High density lipoprotein (HDL) can undergo similar oxidation steps as those associated with LDL and can be found in blood of subjects with atherosclerotic disease.

Markers for cardiovascular disease can include one or more of ox-HDL, ox-LDL, ox-HDL in combination with ox-LDL, or combinations of variably oxidized lipoproteins, in addition to HDL/LDL ratios. Forms of oxidized lipids, lipoproteins, and proteins can include HDL-MDA, HDL-CUSO4, DDLDL-MDA, SDLDL-CUSO4, ApoA, ApoB, HSA-MDA, HSA-CUSO4, LDL-MDA, and LDL-CUSO4.

Panels composed of multiple pairs of antibodies with different reactivity to various forms of lipid markers can detect more forms of lipoproteins, oxidized lipoproteins (including different degrees of oxidation) and other markers. For example, a certain population or profile of circulating lipids could be detected by an antibody panel. Lipids leaking from a plaque prior to an impending plaque rupture can change the lipoprotein profile in a sample, which could be detected as a different lipid profile by the assay panel. This change would not be detected with a single assay. A change in the profile can result from inflammatory processes. For example, Chlamydia infection can be associated with CVD, and a subject's response to an infection could result in oxidation of lipids and other markers. A panel of antibodies with different sensitivity and specificity can detect these changes.

Samples can be tested from a variety of subjects, such as, for example, people in high risk groups as judged, for example, by age, cholesterol levels, family history, prior medical history, diet, weight, HDL: LDL ratios, blood pressure, smoking, and other cardiac risk factors. Subjects with other inflammatory conditions such as arthritis, infections, Alzheimer's, and the like, can also be tested. Testing of samples collected from subjects at different times before, during or after an event (e.g., ACS, stroke, stable angina, or unstable angina), can help to elucidate the timing of the event and the changes in lipid profiles that occur.

Information related to the target compounds determined from the analysis can be used, for example, during or after a health-related event of a subject. For example, the subject may be administered one or more drugs as part of a therapeutic and/or monitoring routine related to a cardiac event. Samples from the subject are assayed to determine one or more target compounds related to the administered drug(s) and related biomarkers. Information from the assays can be used, for example, to determine the severity and/or type of cardiac event and/or monitor the efficacy of a therapeutic routine. Exemplary biomarkers include biomarkers related to ischemia or cardiac necrosis.

Other biomarkers can include, for example, urotensin II, urotensin related peptide, prourotensin II, prourotensin related peptide, oxidized low-density lipoprotein (ox-LDL), malondialdehyde-modified LDL (MDA-LDL), oxygen regulated protein 150 (ORP150, also known as hypoxia upregulated 1 (Hyou1), or Cab140), relaxin (also known as RLX), soluble CD40Ligand/TRAP (sCD40L), C-reactive protein (hsCRP), interleukin-6 (IL6, also known as interferon Beta-2 (IFNB2), B-cell differentiation factor, B-cell stimulatory factor 2 (BSF2), hepatocyte stimulatory factor (HSF), hybridoma growth factor (HGF)), placental growth factor (PGF), soluble P-selectin (also known as P-selectin, sP-Selectin), medroxyprogesterone acetate (MPA), soluble fibrin (also known as s-Fibrin, SF), matrix metalloproteinase 9 (MMP-9, also known as GELB, CLG4B, gelatinase B, 92 kDa gelatinase, 92 kDa type IV collagenase), myeloperoxidase (MPO), asymmetric dimethylarginine (ADMA), lipoprotein phospholipase A2 (Lp-PLA2), pregnancy-associated plasma protein-A (P-APPA), proteinase activated receptor 1 (PAR-1), thrombin receptor Coagulation factor II receptor (CF2R, TR), poly-ADP ribose polymerase (P-PARP), Troponin (for example, Troponin-I), CK-MB, myoglobin, Nourin-1, ischemia modified albumin (IMA), BNP/Pro-BNP, isoprostanes, uroguanylin, prouroguanylin, cardiolipin, cathepsin, cystatin C, cytochrome c, Fas and Fas ligand (also known as CD95, APO-1), Choline, Caspase-1 (also known as interluekin converting enzyme (ICE)), Creatinine, Atrial Natriuretic Peptide (ANP/N-ANP), or osteoprotegerin (also known as OPG/OCIF).

Physicians can use test results to help guide treatment decisions. When the physician can obtain information relating a subject's physiological state (e.g., a level of a biomarker) and the subject's response to a treatment regimen (e.g., tolerance or metabolism of a drug, or other information relating to response to a therapy), the physician can make informed decisions regarding the course of ongoing treatment: whether to continue or discontinue a particular drug, alter a dose of a drug, or prescribe a different class of drugs, and the like. In some circumstances, a single sample can be tested for multiple markers in a single experiment, simplifying the lab work required to provide the physician with the desired information.

For example, a level of oxidized LDLs can be helpful in deciding whether to prescribe a statin to a patient. Higher levels of oxidized LDLs will favor the use of a statin, because statins have been shown to have an antioxidant activity in addition to LDL-lowering activity. Thus, a subject sample can be tested for oxidized LDL and for the statin and/or metabolite of the statin, or some other marker indicative of LDL metabolism and/or statin metabolism.

A level of soluble CD40 can aid in deciding whether to give a GPIIbIIIa inhibitor. A subject sample can be tested for CD40 and for the GPIIbIIIa inhibitor and/or metabolite of the GPIIbIIIa inhibitor, or some other marker indicative of CD40 response or metabolism and/or GPIbIIIa inhibitor response or metabolism.

A BNP measurement, or an ischemia-modified albumin (IMA) measurement, can indicate the desirability of treating heart failure with a vasodilator as opposed to diuretics. A subject sample can be tested for BNP, IMA, or both, and for the vasodilator, diuretic, or both and/or metabolite of the vasodilator, diuretic, or both, or some other marker indicative of BNP or IMA response or metabolism and/or vasodilator, diuretic, or both response or metabolism.

A free fatty acid test can indicate whether or not a PPAR agonist (such as, for example, rosiglitazone) should be given. A subject sample can be tested for free fatty acid and for the PPAR agonist and/or metabolite of the PPAR agonist or some other marker indicative of free fatty acid response or metabolism and/or PPAR agonist response or metabolism.

A BNP test can also suggest the need for ACE inhibitor treatment in heart failure. When an ACE inhibitor is given, the patient can be further tested for creatinine levels, to monitor side effects on kidney function. A subject sample can be tested for BNP and for the ACE inhibitor and/or metabolite of the ACE inhibitor or some other marker indicative of BNP response or metabolism and/or ACE inhibitor response or metabolism.

As an example, patients who are candidates for HMG-CoA reductase inhibitor treatment (i.e., statin treatment) can be tested to follow therapeutic efficacy and safety, in order to increase patient compliance. An assay can measure both positive indicators of therapeutic effectiveness, and markers indicating a clear safety profile. The assay can include tests of markers of endothelial dysfunction, inflammation, plaque stability, systolic function and markers relating to safety.

One safety issue of particular concern for patients taking statins is rhabdomyolysis. Rhabdomyolysis is a disorder which affects the integrity of the sarcolemma of skeletal muscle. This results in the release of potentially toxic biomarkers into the circulation. This in turn can result in potentially fatal complications including myoglobinuric acute renal failure, hyperkalaemia and cardiac arrest.

One diagnostic indicator of rhabdomyolysis can be an elevated serum creatine phosphokinase (CK) to at least five times the normal value. This elevated level of CK excludes myocardial infarction and other causes. The CK-MM isoenzyme predominates in rhabdomyolysis, comprising at least 98% of the total value.

Patients who are taking statins can be assayed for levels of a marker of inflammation such as C-reactive protein (CRP), a marker of endothelial function such as oxidised LDL, a marker of plaque stability such as matrix metalloproteinase 9 (MMP-9) and a marker of systolic function such as brain natriuretic peptide (BNP) or NT-proBNP, a marker of rhabdomyolysis such as CK or skeletal troponin I, or a combination thereof. Thus, information is provided as to the patient's risk profile (particularly with respect to rhabdomyolysis) while undergoing statin treatment. The information can be used to maintain or modify the statin treatment as indicated.

Markers of Left Ventricular Volume Overload and Myocardial Stretch

Measurement of neurohormones has been explored by the research community for several decades. Biomarkers that have been investigated include the natriuretic peptides, A-type-(ANP), B-type-(BNP), and C-type-(CNP) natriuretic peptide and their N-terminal prohormones (N-ANP, N-BNP, and N—CNP). ANP (also known as atrial natriuretic peptide) and its inactive form, N-ANP, have been described in, for example, Hall, Eur J Heart Fail, 2001, 3:395-397, which is incorporated by reference in its entirety.

BNP (the active peptide) and N-BNP (the inactive peptide) are found in the circulation. Both peptides are derived from the intact precursor, proBNP, which is released from cardiac myocytes in the left ventricle. Increased production of BNP (or N-BNP; the abbreviation BNP refers to either form of the B-type natriuretic peptide throughout this document) is triggered by myocardial stretch, myocardial tension, and myocardial injury. Studies have demonstrated a positive correlation between circulating levels of BNP, left ventricular volume overload (e.g., left ventricular end diastolic pressure), and an inverse correlation to left ventricular function (e.g., left ventricular ejection fraction and left ventricular mass index).

Measurement of natriuretic peptides, in particular BNP, has been mainly limited to diagnosis of acute decompensation in suspected heart failure patients in the Emergency Department in a hospital setting, providing a prognosis for patients with acute decompensation during hospitalization, and therapy tracking of patients with acute decompensation prior to discharge from hospital. More recent work has investigated the role of BNP during clinic visits and demonstrated that BNP correlates with improvement in the patient's functional status. See, for example, Kolino M; Am J. Med. 1995 March; 98(3):257-65, which is incorporated by reference in its entirety. However, testing was infrequent—tests were conducted at baseline, 6 months, and 12 months. Similarly, the study by Kawai (Kawai K; Am Heart J. 2001 June; 141(6):925-32, which is incorporated by reference in its entirety) was limited to testing intervals at baseline, 2 months, and 6 months. Studies by Troughton, Latini and McKelvie also used a testing interval of 4 months or greater (see Lancet 2000, 355:1126-30; Circulation 2002 Nov. 5; 106(19):2454-8; and Circulation 1999 Sep. 7; 100(10):1056-64, respectively, each of which is incorporated by reference in its entirety).

The shortest testing interval was used by Murdoch (Murdoch DR; Am Heart J. 1999 December; 138(6 Pt 1):1126-32, which is incorporated by reference in its entirety). Murdoch used a testing interval of every two weeks, but the study did not consider event detection, safe titration of therapy (by using a GFR marker; see below) or an out-patient or homecare setting.

The only study to have used a higher testing frequency (Braunschweig, F; J Cardiovasc Electrophysiol. 2002 January; 13(1 Suppl):S68-72, which is incorporated by reference in its entirety) investigated the correlation of BNP to weight gain and hemodynamics. A major limitation of this study was the long testing interval of weekly blood draws and again the failure to consider the use of BNP and a GFR marker in a home care setting—in fact, the purpose of the study was to evaluate an implanted hemodynamic sensor and compare this to weight tracking.

There is a danger that the patient or caregiver will drive the patient to a state of under-hydration if they rely on BNP levels alone. Furthermore, a target BNP level for one patient might be unsuitable for another patient because of factors such as age, gender, body mass index, extent of hypertrophy, etc.

In the studies discussed above, the patient and their caregiver did not have access to objective data at a suitable testing interval to allow the prevention of future events (e.g. acute decompensation), rapid drug optimization (e.g. ACE inhibitors, β-blockers, aldosterone receptor blocker), and controlled dose adjustment of diuretics without putting the patient at risk.

Markers of Myocardial Apoptosis or Injury

Markers of myocardial apoptosis provide information on cardiac remodeling, which is an effect of left ventricular volume overload. Measurement of increased myocyte apoptosis arising from excessive myocardial stretch, norepinephrine toxicity, and other proposed mechanisms provide information on cardiac remodeling. Suitable markers include cardiac troponins, including the isoforms troponin I and troponin T (TnI and TnT, respectively), as well as urotensin in all its forms and urotensin-related peptides. Measurement of troponin has traditionally been used to provide a diagnosis of myocardial injury or infarction, distinct from the process of apoptosis. A sensitive immunoassay for a troponin isoform can allow a healthcare provider to obtain information on the extent of myocyte apoptosis and myocyte damage induced by the aforementioned mechanisms or consistent with myocardial ischemia and infarction.

Cardiac troponin levels are frequently above normal values in several disease states in which myocardial necrosis is not a prominent aspect, particularly in pulmonary embolism, heart failure, liver cirrhosis, septic shock, renal failure and arterial hypertension. Sub-clinical myocardial necrosis and increased myocardial apoptosis has been postulated to be the cause of the phenomenon. Increased troponin levels may be the result of ventricular dilatation or hypertrophy. Troponin may act as a marker of myocardial strain, injury, and increased apoptosis (e.g., during acute decompensation or chronic worsening pre-heart failure, heart failure, and hypertension). Apoptosis contributes to myocardiocyte loss in cardiac disease and may have a pathophysiologic role in left ventricular (LV) remodeling. Heart failure is associated with an increase in apoptosis rate and is significantly correlated with parameters of progressive left ventricle remodeling. Low levels of troponin in the circulation correlate with apoptosis rate.

Elevated levels of troponin without elevated levels of creatine kinase is thought to be due to release of troponin from myocardial cells without the disruption of myocardial cell plasma membrane.

Chen measured troponin in the plasma of patients with heart failure. See Chen Y N, Ann Clin Biochem. 1999 July; 36 (Pt 4):433-7, which is incorporated by reference in its entirety. Elevated plasma troponin concentrations were found in 89% of heart failure patients while plasma creatine kinase-MB (CK-MB) showed no significant difference. During follow-up, serial measurements of cardiac TnI and CK-MB were performed. In heart failure patients, improvement of the clinical profile was associated with declining troponin concentrations, while deterioration of heart function was closely related to increasing troponin concentrations. Cardiac damage relates to functionally overloaded myocytes and troponin may be a sensitive marker both for early detection of myocyte damage and for monitoring of function and prognosis in patients with heart failure. Chen demonstrated that plasma troponin levels that returned to normal in patients whose heart failure was successfully treated had better outcomes than in patients whose troponin remained elevated.

Horwich demonstrated that troponin is elevated in severe heart failure and may predict adverse outcomes (Horwich, T B; Circulation. 2003 Aug. 19; 108(7):833-8, which is incorporated by reference in its entirety). They presented data on 238 patients with advanced heart failure who had troponin assay drawn at the time of initial presentation. Patients with acute myocardial infarction or myocarditis were excluded from analysis. Troponin was detectable (greater than or equal to 0.04 ng/mL) in serum of 117 patients (49.1%). Patients with detectable troponin levels had significantly higher BNP levels and more impaired hemodynamic profiles, including higher pulmonary wedge pressures and lower cardiac indexes. A significant correlation was found between detectable troponin and progressive decline in ejection fraction over time.

Detectable troponin was associated with increased mortality risk. Troponin used in conjunction with BNP improved prognostic value. Therefore, troponin is associated with impaired hemodynamics, elevated BNP levels, and progressive left ventricular dysfunction in patients with heart failure.

Monitoring troponin to detect myocardial infarction in the context of ischemia is already accepted practice (see, for example, Apple FS, European Society of Cardiology and American College of Cardiology guidelines for redefinition of myocardial infarction: how to use existing assays clinically and for clinical trials; Am Heart J. 2002 December; 144(6):981-6, which is incorporated by reference in its entirety).

Therefore, routine measurement of troponin is valuable in the management of the heart failure patient. Serial tracking of troponin will enable information on the patient's condition (whether stable, worsening, or improving) to be determined and will also provide information on future prognosis.

Markers of Inflammation

Inflammation markers can provide information about a patient's condition. A marker of inflammation can be used to predict sudden unexpected death. The marker can be non-specific (i.e., a marker of general inflammation), or specific (i.e., a marker indicating cardiac or vascular inflammation). The marker can be a soluble adhesion molecule (e.g., E-selectin, P-selectin, intracellular adhesion molecule-1, or vascular cell adhesion molecule-1), Nourin-1, a cytokine (e.g., interleukin-1β, -6, -8, and -10 or tumor necrosis factor-alpha), an acute-phase reactants (e.g., hs-CRP), neutrophils, and white blood cell count.

Markers of Anemia

Markers of anemia can also be valuable in tracking heart failure patients. According to one study, heart failure patients with low hematocrits had a significantly higher risk of mortality than those with hematocrit >42% (see Kosiborod, M., et al. Am. J. Med. 2003, 114: 112-119, which is incorporated by reference in its entirety). For example, a hemoglobin level or hematocrit measurement can be used as a marker of anemia.

Markers of Myocardial Ischemia

Markers of myocardial ischemia provide independent information on cardiac output, thrombus formation and embolization, and vascular blood flow. Measurement of such markers (e.g., ischemia-modified albumin, oxygen-regulated peptide (ORP150), free fatty acid, Nourin-1, urotensin in all its forms and urotensin-related peptides, and other known markers) provide an indication of onset of ischemia, magnitude of ischemia, and natural or induced reperfusion.

Markers of Renal Function

The easiest way to measure the glomerular filtration rate (GFR) is with creatinine (Robertshaw M, Lai K N, Swaminathan R. Br J Clin Pharmacol 1989; 28:275-280, which is incorporated by reference in its entirety). The rate of creatinine addition to the body is proportional to body muscle mass. The rate of creatinine removal is proportional to the concentration in the plasma and the rate of glomerular filtration. For example, a decrease of GFR from 120 mL/min to 60 mL/min would increase the plasma creatinine from 1.0 mg/dL to 2.0 mg/dL. Thus, changes in GFR are mirrored by reciprocal changes in the serum creatinine. Because serum creatinine multiplied by GFR equals the rate of creatinine production, a decrease in the GFR by 50% will cause the serum creatinine to increase by a factor of two at steady-state. Using only a serum or plasma creatinine measurement, the GFR, in mL/min, can be estimated using the formula: GFR=(140−age)×weight (kg)/0.825×plasma creatinine (μmol/L).

Markers of renal function should be monitored regularly in patients on ACE inhibitors, angiotensin II receptor inhibitors, and diuretics. A limited elevation in creatinine level (30 percent or less above baseline) was seen following initiation of therapy with an ACE inhibitor or angiotensin II receptor inhibitors. The increase usually occurred within two weeks of therapy. Regardless of the creatinine value, manifestations of renal failure were not apparent until the GFR was well below 30 mL per minute. Patients with the greatest degree of renal insufficiency experienced the greatest protection from renal disease progression. Hence, upon initiation of an ACE inhibitor or angiotensin II receptor inhibitor, GFR should be monitored, but a decrease is not a reason to withdraw therapy.

The study by Lee (Lee S W; Am J Kidney Dis. 2003 June; 41(6): 1257-66, which is incorporated by reference in its entirety) revealed that BNP levels are insensitive to under-hydration in patients on hemodialysis. Lee was evaluating whether BNP might be used to assess hydration status in a patient undergoing aggressive hemodialysis. When these findings are applied to the process of diuresis using either intravenous or oral diuretic therapy, one would realize that BNP cannot be used to detect a state of over-diuresis which could be life threatening. Consequently, routine measurement of a glomerular filtration rate marker is necessary to determine whether the patient is at risk of under-hydration through over-use of diuretic therapy.

Several biochemical methods exist for the measurement of GFR. Generally, these measure the level of an analyte that is metabolized at a constant rate, so that an increase in circulating levels of the analyte indicates renal failure. Suitable such analytes include creatinine and Cystatin C. See, for example, Newman, D J, Ann Clin Biochem. 2002 March; 39(Pt 2):89-104; and Perrone R D et al, Clin Chem. 1992 October; 38(10):1933-53: each of which is incorporated by reference in its entirety. Measurement of GFR with creatinine (plasma or serum creatinine) can be achieved with the Cockroft and Gault equation to adjust for age, weight, and gender.

An alternative measurement of GFR can be achieved with Cystatin C. Cystatin C has a low molecular weight and is filtered freely at the glomerular membrane. Cystatin C has been proposed as an alternative and superior marker to serum creatinine. Cystatin C is produced by all nucleated cells and catabolized by renal tubular cells. Its rate of production is constant and is not affected by muscle mass, inflammation, and it does not have a circadian rhythm.

Cystatin C was found to be more specific than serum creatinine in evaluating renal function with a tighter distribution of values around the regression line (Mussap, M; Kidney International, Vol 61 (2001), pp 1453-1461, which is incorporated by reference in its entirety). Mussap also reported that Cystatin C rises earlier and more rapidly than serum creatinine as GFR decreases—it has higher sensitivity than both serum creatinine and GFR derived from the Cockroft-Gault equation. commercial test for serum Cystatin C is available from Dade Behring (nephelometric assay; N-latex Cystatin C Assay; 6 minute test).

Markers of Electrolyte Balance

Electrolyte balance is the condition where a patient's electrolytes (for example, soluble ions such as Na⁺ and K⁺) are in the normal concentration range. The subject may be a heart failure patient with a stable condition, a heart failure patient with an unstable condition, a patient with mild, moderate, or advanced hypertension, or a patient with recent myocardial infarction. Typical values of normal fluid and electrolyte balance are as follows and are dependent upon the age and sex of the individual: for an average 70 kg man the total body water is typically 42 L (˜60% of body weight), with 28 L being in the intracellular and 14 L in the extracellular compartments. The plasma volume is 3 L and the extravascular volume is 11 L. Total body Na⁺ is typically 4200 mmol (50% in extracellular fluid, (ECF)) and the total body K⁺ is typically 3500 mmol (about 50-60 mmol in ECF). The normal osmolality of ECF is 280-295 mosmol/kg.

Hypokalemia is a common adverse effect of diuretic therapy and may also increase the risk of digitalis toxicity. Hence, plasma or serum potassium levels should be routinely measured in heart failure patients in order to avoid such undesirable side effects. Potassium is typically measured using an ion-selective electrode (e.g. i-STAT, i-STAT Corp.)

### Markers of Sodium Retention

Markers of sodium retention or excessive sodium intake can provide an estimate of sodium retention, electrolyte balance, and sodium consumption. One suitable marker is uroguanylin, which is an intestinal natriuretic hormone and functions as an endocrine modulator of sodium homeostasis. In a patient with congestive heart failure, levels of uroguanylin measured in urine are known to be substantially higher than in controls. The increased urinary uroguanylin excretion in patients with heart failure may be an adaptive response. The urinary excretion of uroguanylin is significantly higher in the presence of a high salt diet and significantly correlated with urinary sodium. Measurement of uroguanylin can provide unique information on sodium homeostasis and the patient's status. Such measurement may be used to make decisions on intake of fluid and sodium to avoid adverse events.

Information related to the target compounds determined from the analysis can be used to determine unwanted effects (e.g., toxic effects) of a drug or drug combination.

Information related to the target compounds determined from the analysis can be used to determine heterogeneity in subject response to a drug or routine. For example, at least one biomarker can be indicative of a patient heterogeneity (e.g., a susceptibility to a particular condition).

Typical biological samples include biological materials that may contain one or more drug-related compounds and/or one or more biological markers. Exemplary biological samples include biological fluids (e.g., blood, plasma, saliva, tear fluid, urine, spinal fluid (e.g., cerebral spinal fluid)). Biological samples may also be derived from other biological materials (e.g., tissues and hair) of a subject. Subjects from which biological samples (e.g., biological fluids and other biological materials) are obtained are typically mammals (e.g., humans as well as rodents, hares, rabbits, guinea pigs, pigs, and other non-human mammals). Samples may be obtained from non-mammals. Information determined using the devices and methods described herein can be used, for example, in translation medicine (e.g., to predict or understand a human response to a drug based on a response of one or more non-human animals).

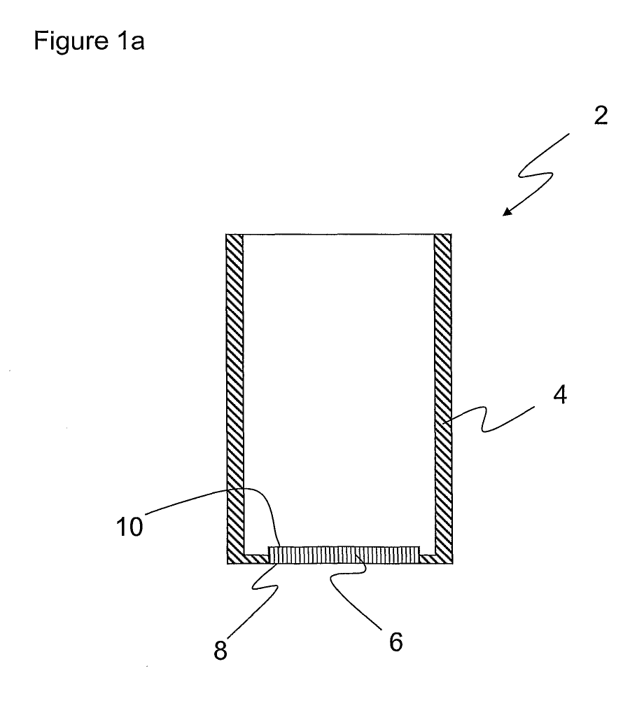

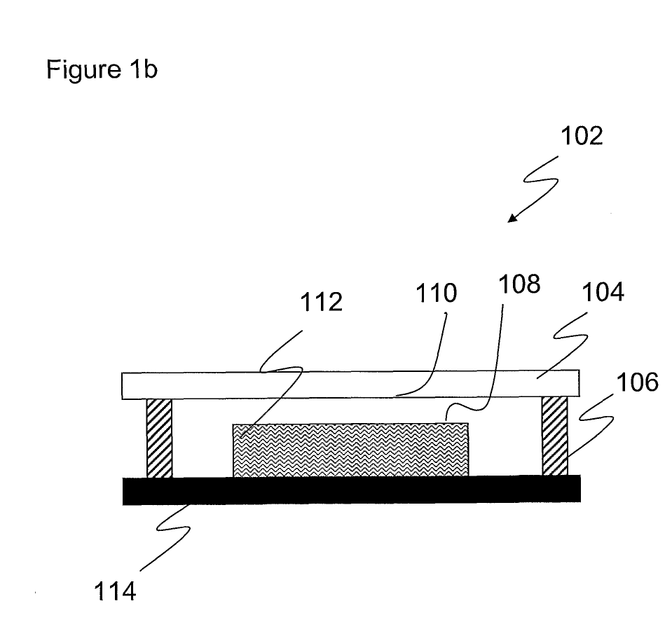

Referring to FIG. 1a, a reaction chamber 2 is configured for use in a device configured to assay a sample for one or more target compounds. Chamber 2 includes a chamber wall 4, a sensor chip 6 having a capture surface 10, and an optical window 8. Reaction chamber 2 is used to contain a sample which includes one or more target compounds (e.g., drug-related compound(s), biological marker(s), and/or biological(s)). Chamber wall 4 is typically formed from a material (e.g., a polymer such as polypropylene) that is bioinert with respect to the sample. See, for example, U.S. Patent Application Publication No. 2005/0064469, which is incorporated by reference in its entirety.

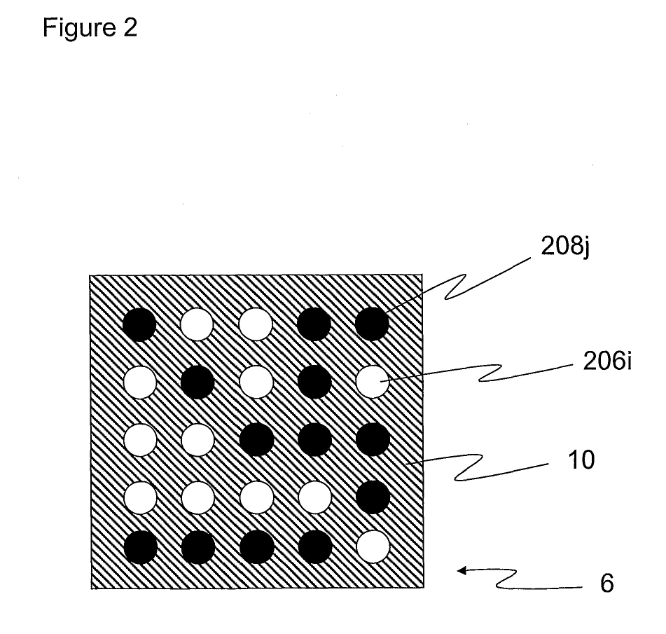

Referring to FIG. 2, capture surface 10 of sensor chip 6 includes first and second subsets ∘, of binding compounds 206i and 208j. Each binding compound 206i, 208j of the first and second subsets typically has an affinity (e.g., binds preferentially or specifically) for a respective target compound. Each binding compound 206i of the first subsets has an affinity for a respective biomarker (or analogue thereof). Each binding compound 208j of the second subset has an affinity for a respective drug-related compound (or analogue thereof).

First and second subsets ∘, include a number Ni and Nj different binding compounds respectively. Ni and Nj are each typically and independently at least one (e.g., at least about 2, at least about 3, at least about 5, at least about 10, at least about 15, at least about 25). Each binding compounds 206i, 208j is typically disposed at a respective assay site of capture surface 10. The different sites are typically configured as an array (e.g., a regular array or a random configuration).

Each assay site typically includes a single binding compound but, in some embodiments, at least some assay sites include more than one binding compound. The device can include one or more additional subsets of binding compounds. The binding compounds of each additional subset each have an affinity for a different target compound (e.g., a different drug related compound or biomarker).

Sensor chip 6 is formed of a material that allows measurement (e.g., optical, electrochemical, or radioactive) of binding to binding compounds 206i, 208j). In some embodiments, sensor chip 6 is optically transparent for at least some wavelengths and is formed of a material that exhibits low or no fluorescence at a wavelength used to monitor sensor 6. Sensor 6 is fixedly mounted with respect to chamber wall 4 within reaction chamber 2 such that it forms part of the base of reaction chamber 2. Sensor chip 6 defines optical window 8 which may be integrated with a measurement device (e.g., a fluorimeter or a spectrophotometer) (not shown).

The sensor chip may be patterned with an array of one or more immobilised binding compounds, as described by FIG. 2. Interrogation of the array of immobilised binding compounds may be achieved using, for example, a scanning optical read head, which can be moved back and forth across the immobilised capture molecule array. Equally however, a two-dimension detector (e.g., a charge coupled device (CCD) array, charge injection detector (CID) or complementary metal oxide semiconductor (CMOS) array) may be used to acquire image information related to the respective binding compounds. The acquired optical signal, which may be, for example, a fluorescence signal, reflectance signal, scatting signal, interference signal, absorption, or luminescence signal, may be used to determine quantitative and/or qualitative information related to target compounds bound (directly or indirectly) with respect to the immobilised binding compound.

At least some assay sites may be configured to participate in a competitive binding assay for a target compound. Typically, a competitive binding assay site includes a binding compound immobilized with respect to the substrate. A labelled compound (e.g., a labelled target compound or labelled analogue of a target compound) is reversibly bound to the binding compound. In use, target compound present in a sample replaces the labelled compound bound to the binding compound of the competitive binding assay site. This replacement results in a reduction in signal from the label.

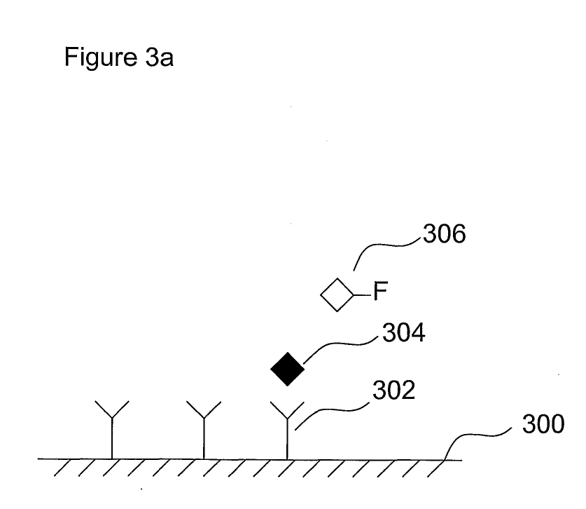

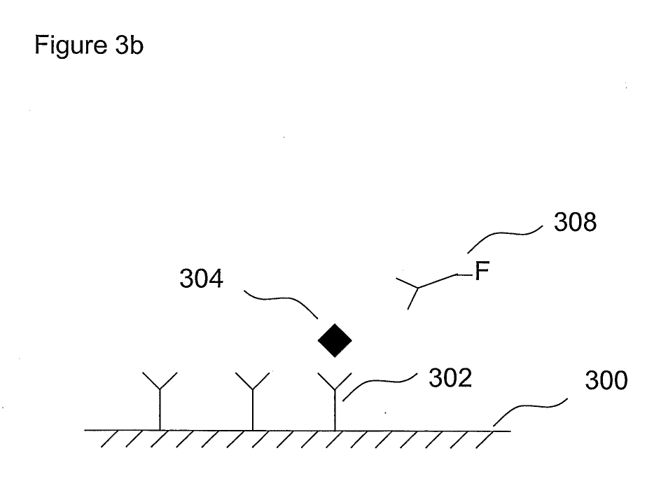

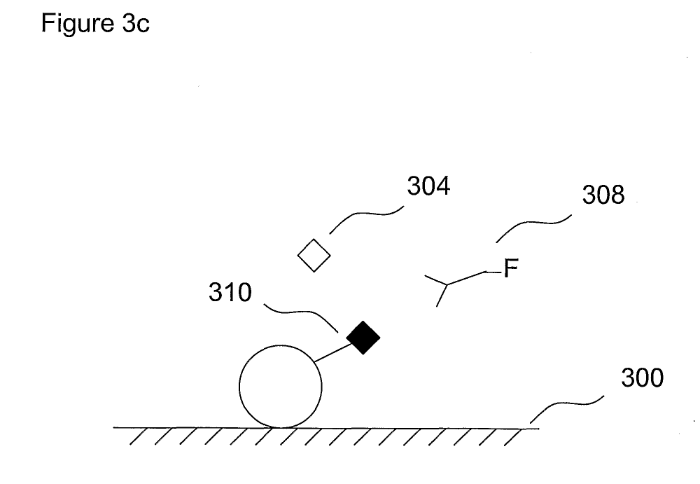

FIG. 3a represents a schematic representation of a competitive binding assay for a drug or biomarker. A measurement surface 300 is pre-coated with a series of antibodies 302, for example, according to the array pattern of FIG. 2. Antibody 302 has an affinity for a target compound 304, which may be present in a sample. A labeled (e.g. fluorescently labeled) compound 306 is provided within the assay mixture. Labeled compound 306 competes with target compound 304 for binding with antibodies 302. A detector determines the amount of labeled compound 306 bound to antibodies 302. The detected signal (e.g., fluorescence) is inversely proportional to the amount of target compound present.

FIG. 3c represents another competition assay for a target compound. A measurement surface 300 is pre-coated with a conjugated target compound 310 (e.g., a conjugated drug), for example, according to the array pattern of FIG. 2. A labeled antibody 308 is specific for drug or small molecule 304, which may be present in a sample. A labeled (e.g. fluorescently labeled) antibody 308 is provided within the assay mixture. When a sample that contains small molecule 304 is applied to measurement surface 300, labeled antibody 308 will bind competitively to small molecule 304 and conjugated target compound 310. The intensity of the signal measured when the binding reaction has gone to completion is inversely proportional to the amount of small molecule 304 present in the sample.

When configured in a sandwich assay format a secondary antibody which is labelled with a suitable label, which may be an optical label or an enzyme label is also used. The secondary labelled antibody must be able to bind to the target molecule when the target molecule has been captured on the primary antibody, which is immobilised on the sensor surface.

FIG. 3b represents a schematic representation of a sandwich assay for a drug. A measurement surface 300 is pre-coated with a series of antibodies 302 according to the array pattern of FIG. 2. Antibody 302 is specific for drug or biomarker 304, which may be present in a sample. A labeled (e.g. fluorescence label) antibody 308 is provided within the assay mixture such that the labeled antibody will bind to the target compound (e.g. a drug or biomarker) 304 that is captured on antibody 302. The sandwich assay format is suitable for detection of drugs or biomarkers that are sufficiently large to permit binding of at least 2 antibodies simultaneously (e.g., with little or no overlap of the epitope to which the antibody is raised). The measured fluorescent signal that is obtained shows a positive correlation with the amount of target compound 304 present in the sample.

In use, a sample suspected of having one or more target compounds is obtained from a subject, either a human or animal. The sample is combined with a reagent that includes a binding compound capable recognising the target. Typically, the binding compound is labelled (e.g., fluorescently). The reagent may be located in the chamber such that when the sample enters the chamber the binding compound is solubilised and allowed to bind to target compound in the sample. Typically there is one binding compound per target compound.

The sample is applied to the sensor array and an initial response profile is obtained which demonstrates the basal profile. A drug or drug combination may then be administered to the subject and additional samples may be obtained at a range of time points thereafter. Analysis of the samples acquired following administration of the drug(s) may be used to demonstrate in real time the effect of the drugs on the circulating levels of one or more biomarkers.

The measurement of the binding profile of biomarker/drug interaction with each respective element of the array as depicted in FIG. 2 may be achieved as a change in fluorescence. The intensity of the fluorescent signal may be correlated with the quantity of the material present in the sample. Thus, as a function of time the relative response to each element of the array may change according to the action of the drug(s) on the subject.

Referring to FIG. 1b, an assay device includes a reaction chamber 102, an optical window 104, a compressible gasket 106, a measurement surface 108, an optical surface 110, a sensor chip 112, and a sensor base 114. See, for example, International Patent Application Publication No. WO 2005/108604, and U.S. patent application Ser. No. 11/593,021, filed on Nov. 6, 2006, titled “Method and Device for the Detection of Molecular Interactions,” each of which is which is incorporated by reference in its entirety.

Reaction chamber 102 defines an enclosed region in which sample may be contained. Reaction chamber is defined by an optical window 104 on an upper face and sensor base 114 on a lower face. A compressible gasket 106 forms a continuous side wall that joins optical window 104 and sensor base 114 to provide a liquid seal. Sensor chip 112 is fixedly mounted onto sensor base 114 beneath optical window 104. Sensor chip 112 has a measurement surface 108 upon which may be immobilised one or more binding compounds, that may be arranged in an array. Optical window 104 has an optical surface 110 which is located above measurement surface 108.

During use a sample may be introduced to reaction chamber 102 by direct injection through compressible gasket 106 using a hypodermic needle (not shown). A compressive force may be applied to optical window 104 and sensor base 114 such that compressible gasket 106 is compressed. When compressible gasket 106 is compressed sufficiently measurement surface 108 may be brought into contact with optical surface 110. The action of closing the gap between measurement surface 108 and optical surface 110 causes any material that is not bound to measurement surface 108 to be expelled from between optical surface 110 and measurement surface 108, thereby permitting measurement of captured material free from unbound material.

### EXAMPLES

### Example 1

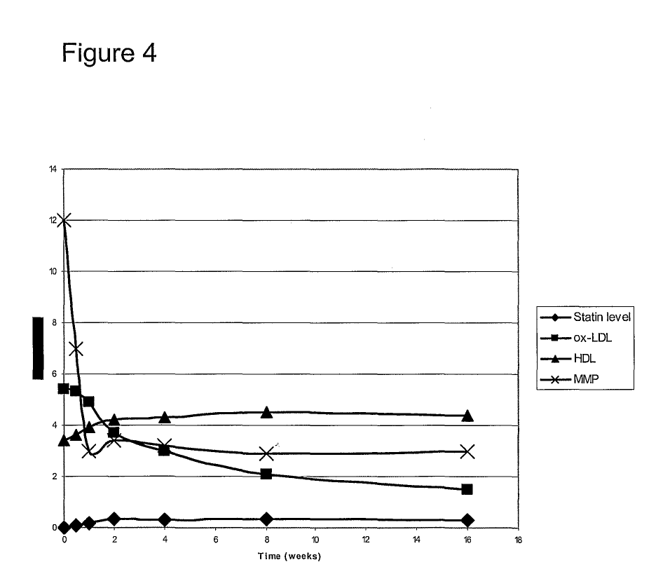

A device is used to assay a sample for a statin and for multiple biomarkers. A sensor surface is prepared to determine Rosuvastatin (Crestor™) and the biomarkers oxidized LDL, non-oxidized HDL, MMP-1, MMP-9. Sensors are produced by coating of individual array elements (as shown in FIG. 2) with the respective binding compound (e.g., antibody or drug conjugate) necessary to detect the binding of the desired target compound(s). FIG. 4 indicates that as a function of time from the initial administration of a statin to the subject measurable changes occur in the circulating level of the drug within, for example, the blood of the subject.

FIG. 4 shows that the level of statin is expected to initially rise until a stable level, which may be a therapeutic level, is attained. The device thereby provides information that may be used to monitor the compliance of the subject with the prescribed therapeutic regimen. Any perturbation of the statin level may be associated with a failure to maintain the regimen; equally however, it may also indicate other effects that would enable the physician in charge of the subject to take the appropriate steps to regain the desired level of drug.

FIG. 4 also shows the levels of several biomarkers present in a sample. MMP-1 is a biomarker associated with plaque instability or vulnerability. MMPs when present at elevated levels are known to cause breakdown of collagen within a plaque wall, which if unchecked may lead to destabilization of the plaque. Similarly, another marker of interest is oxidized-LDL. Statins are known to effect lowering of LDL and elevation of HDL, the ratio of which is taken as an indicator of the state of health of the subject. It is desirable to have a relatively low LDL level. The data shown in FIG. 4 indicate that as a function of time following statin therapy levels of LDL may reduce, whereas levels of HDL may rise.

Thus the present invention may be used to provide a panel of data that indicate the progression of statin treatment. Not only would the physician gain rapid understanding of the impact of the therapy, but also indicative data showing compliance with the regimen.

### Example 2

In a further aspect of the invention a measurement surface may be used to assess a panel of markers known to be associated with cardiac status. Antibodies raised to Troponin-I (TpI), ischemia modified albumin (IMA) and brain natriuretic peptide (BNP) are immobilized onto the surface of a sensor chip as described with reference to FIG. 2. The relative ratio of each marker may be used as an indicator of ischemic state, as described in Appendix A.

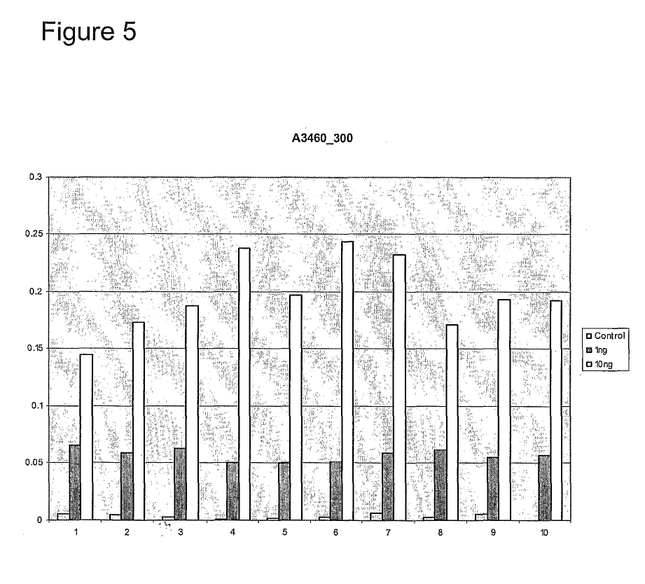

FIG. 5 indicates an exemplary response profile to TpI. A number of discrete zones on a sensor array were coated with an antibody, clone A3460, that had been raised to TpI. The primary antibodies were incubated with the sensor surface for a defined time, typically between about 15 and 30 minutes. Samples of blood to which had been added known quantities of TpI were assayed to determine the sensitivity of the assay. The data shown in FIG. 5 represent measurements recorded at no added TpI, 1 ng/mL TpI and 10 ng/mL TpI in a control blood sample. An assay was performed as described with respect to FIG. 3b, wherein a first antibody to TpI labeled with a fluorescent probe was premixed with a sample of blood containing TpI. After an initial incubation at about 40 C for about 15 minutes the blood sample was introduced to the sensor surface and a further period of incubation allowed before a fluorescent intensity was recorded.

When measurements were performed in a device according to FIG. 1a the sensor chip was first washed with buffer solution to remove excess and unbound labeled antibody before the optical window was placed in contact with a CCD array scanner. An illuminating light source was shone through the device such that a measurement was made of the fluorescent label was made on the opposite side of the sensor chip to which the illuminating light was provided.

However, when measurements were conducted in a device according to FIG. 1b the optical window and sensor base were compressed together to exclude unbound labeled antibody from the vicinity of the measurement zone. A CCD array scanner was then used to determine the fluorescence intensity of the respective test zones on the sensor array. The sensor chip array was illuminated using a dichroic mirror arrangement, such that the illuminating light and reflected fluorescent signal were directed through the same side of the sensor chip. The data shown in FIG. 5 demonstrate a concentration dependant response to TpI. A sensor array can determine multiple measurement responses from a single sample essentially simultaneously.

### Example 3

A surface is modified with multiple assay sites. At least one respect assay site included a binding compound configured to participate in an assay for troponin I, BNP, CKMB, and myoglobin.

### Example 4

Antibodies to various forms of oxidized lipids, lipoproteins and proteins (HDL-MDA, HDL-CUSO4, DDLDL-MDA, SDLDL-CUSO4, ApoA, ApoB, HSA-MDA, HSA-CUSO4, LDL-MDA, LDL-CUSO4) were generated. The antibodies were spotted on epoxy-modified glass surfaces. For that purpose the antibodies were diluted in PBS buffer pH 7.4, 20 mM Trehalose. Final concentration of the antibodies was 500 ng/mL. Spotting was done by contacting the surface of the glass with capillaries filled with 5 μL of the antibody spotting solution. Arrays were mounted to a device of the type illustrated in FIG. 1a. The immobilized antibodies served as capture probes in the assay.

All antibodies were labeled with Biotin using a commercial biotinylation kit (EZ-Link Sulfo-NHS-LC-Biotin, Pierce). The amount of biotin incorporation was measured with the HABA-assay (reagents and protocol provided with the Pierce Biotin labeling kit). The average degree of labeling was 2-3 mol Biotin per mol antibody. The Biotin-labeled antibodies served as detection antibodies in the screening assay.

The experimental protocol was as follows. Antigens were diluted in PBS with 0.25% TritonX-100 and 0.5% BSA to give the required final concentration of the antigen. Biotin-labeled detection antibody was then added, to give a final concentration in the range of 10 μg/mL to 100 ng/mL, depending on the antibody. The solution was added to the array-mounted device.

Next, the solution was incubated for 15 min at 37° C. and 800 rpm in a thermal shaker. The arrays were washed for 2 min at 37° C. and 800 rpm, once with PBS pH 7.4, 0.1% Triton X-100 and twice with PBS pH 7.4. Then, 100 μL of 1:10,000 diluted Streptavidin-HRP conjugate (Pierce) in 1×PBS pH 7.4, 1% BSA was added. The incubation and washing steps were repeated and the final wash buffer removed.

Next, 100 μL of True Blue TMB substrate (KPL) was added, and the array was incubated with the substrate for 10 min at 25° C. The TMB precipitate was detected optically using a microscope-coupled CCD detector. The resulting image was then analyzed to determine which array locations (i.e., which capture antibodies) successfully captured antigen and were capable of forming productive sandwich complexes with the antigen and the detection antibody.

Other embodiments are within the scope of the following claims.

What is claimed is:

1. A device, comprising:
a plurality of assay sites, the plurality including a first subset of assay sites configured to determine a first biological marker, and a second subset of assay sites configured to determine a first drug-related compound.

2. The device of claim 1, further comprising a sample inlet, wherein the first and second subsets of assay sites are in fluidic communication with the sample inlet.

3. The device of claim 1, wherein the biological marker is associated with a disease or disorder, and the drug-related compound is associated with the disease or disorder.

4. The device of claim 1, further comprising a third subset of assay sites configured to determine a second biological marker.

5. The device of claim 1, further comprising a fourth subset of assay sites configured to determine a second drug-related compound.

6. The device of claim 5, wherein the second subset of assay sites is configured to determine a drug, and the third subset of assay sites is configured to determine a metabolite of the drug.

7. The device of claim 1, wherein the first subset of assay sites is configured to determine an oxidized lipid.

8. The device of claim 7, wherein the first subset of assay sites is configured to determine HDL, LDL, HDL-ox, LDL-ox, HDL-MDA, HDL-CUSO4, DDLDL-MDA, SDLDL-CUSO4, ApoA, ApoB, HSA-MDA, HSA-CUSO4, LDL-MDA, or LDL-CUSO4.

9. The device of claim 8, wherein the second subset of assay sites is configured to determine a drug or drug metabolite.

10. The device of claim 9, wherein the drug or drug metabolite is associated with a cardiac disease or disorder.

11. The device of claim 10, wherein the plurality further includes a third subset of assay sites configured to determine HDL, LDL, HDL-ox, LDL-ox, HDL-MDA, HDL-CUSO4, DDLDL-MDA, SDLDL-CUSO4, ApoA, ApoB, HSA-MDA, HSA-CUSO4, LDL-MDA, or LDL-CUSO4.

12. A method, comprising:
introducing a sample to a device comprising a plurality of assay sites, the plurality including a first subset of assay sites configured to determine a first biological marker, and a second subset of assay sites configured to determine a first drug-related compound,
contacting the first and second subsets of assays with the sample, and
determining at least one biological marker and at least one drug-related compound in the sample.

13. The method of claim 12, wherein the device further comprises a sample inlet, wherein the first and second subsets of assay sites are in fluidic communication with the sample inlet.

14. The method of claim 12, wherein the biological marker is associated with a disease or disorder, and the drug-related compound is associated with the disease or disorder.

15. The method of claim 12, wherein the device further comprises a third subset of assay sites configured to determine a second biological marker.

16. The method of claim 12, wherein the device further comprises a fourth subset of assay sites configured to determine a second drug-related compound.

17. The method of claim 16, wherein the second subset of assay sites is configured to determine a drug, and the third subset of assay sites is configured to determine a metabolite of the drug.

18. The method of claim 12, wherein the first subset of assay sites is configured to determine an oxidized lipid.

19. The method of claim 18, wherein the first subset of assay sites is configured to determine HDL, LDL, HDL-ox, LDL-ox, HDL-MDA, HDL-CUSO4, DDLDL-MDA, SDLDL-CUSO4, ApoA, ApoB, HSA-MDA, HSA-CUSO4, LDL-MDA, or LDL-CUSO4.

20. The method of claim 19, wherein the second subset of assay sites is configured to determine a drug or drug metabolite.

21. The method of claim 20, wherein the drug or drug metabolite is associated with a cardiac disease or disorder.

22. The method of claim 21, wherein the plurality further includes a third subset of assay sites configured to determine HDL, LDL, HDL-ox, LDL-ox, HDL-MDA, HDL-CUSO4, DDLDL-MDA, SDLDL-CUSO4, ApoA, ApoB, HSA-MDA, HSA-CUSO4, LDL-MDA, or LDL-CUSO4.

23. A method of monitoring a subject comprising:
(a) obtaining a sample from the subject;
(b) introducing a sample to a device comprising a plurality of assay sites, the plurality including a first subset of assay sites configured to determine a first biological marker, and a second subset of assay sites configured to determine a first drug-related compound,
(c) contacting the first and second subsets of assays with the sample, and
(d) determining at least one biological marker and at least one drug-related compound in the sample; and
(e) repeating steps (a)-(d) at a later time.
